(19) United States
(12) Patent Application Publication
(10) Pub. No.: US 2014/0379713 A1
(43) Pub. Date: Dec. 25, 2014

(54) COMPUTING A MOMENT FOR CATEGORIZING A DOCUMENT

(71) Applicant: Hewlett-Packard Development Company, L.P., Houston, TX (US)

(72) Inventors: Vinay Deolalikar, Cupertino, CA (US); Hernan Laffitte, Mountain View, CA (US)

(21) Appl. No.: 13/923,500

(22) Filed: Jun. 21, 2013

(51) Int. Cl. G06F 17/30

(52) U.S. Cl. CPC G06F 17/30011
USPC 707/737

(57) ABSTRACT

For documents in a collection, respective data structures containing information representing occurrence of terms in the corresponding documents are generated. For a first one of the documents, at least one moment is computed based on the information in the data structure corresponding to the first document, where the at least one moment represents at least one characteristic of a distribution of values derived from the information in the data structure corresponding to the first document. The at least one moment is useable to categorize the first document into one of a plurality of classes of documents.

### BACKGROUND

Various types of data analyses can be performed on documents. For example, such data analyses can include data mining of the documents to extract information regarding the documents, machine learning based on the documents to train classifiers or other automated entities to classify or perform other processing of documents, and so forth.

### BRIEF DESCRIPTION OF THE DRAWINGS

Some implementations are described with respect to the following figures:

FIG. 1 is a schematic diagram of an arrangement that includes a document categorizer and a moment computation engine, according to some implementations;

FIG. 2 illustrates an example feature vector useable by techniques according to some implementations;

FIG. 3 is a flow diagram of a document categorization process according to some implementations; and

FIG. 4 is a block diagram of an example system according to some implementations.

### DETAILED DESCRIPTION

An enterprise, such as a business concern or other entity, can maintain a document collection that can include a relatively large variety of documents. Examples of the different types of documents include email messages, marketing brochures, text messages, project documents, spreadsheets, financial documents, machine logs, and so forth. Different types of documents can have different formats. More generally, a document can refer to a container of information.

Performing analysis of a document collection that includes a wide variety of documents can be challenging. For example, certain analysis techniques (including data mining techniques, machine learning techniques, and so forth) rely on documents conforming to certain formats. If documents not conforming to such formats are input into such analysis techniques, unexpected or poor results may be returned.

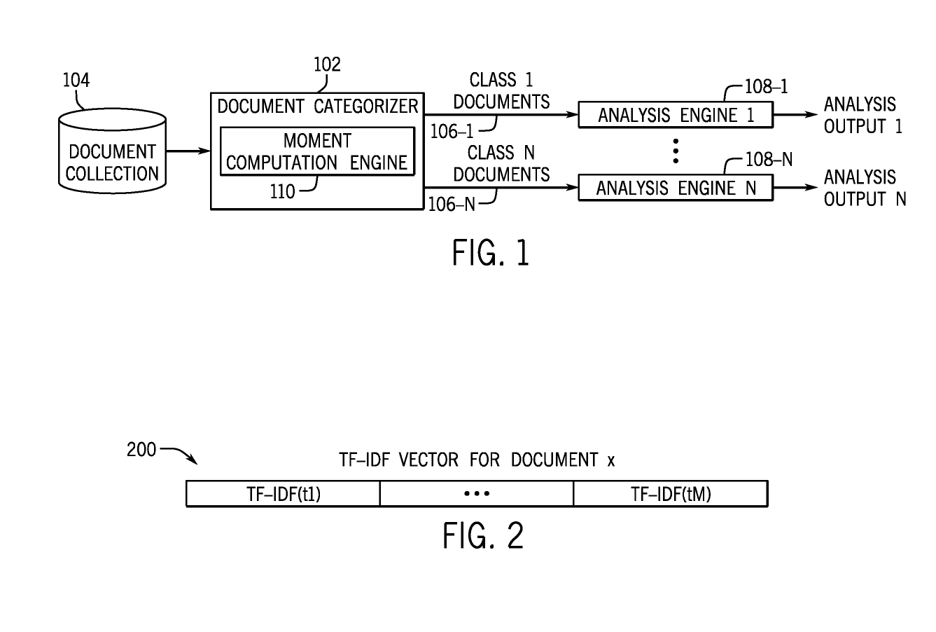

In accordance with some implementations, as depicted in FIG. 1, a document categorizer 102 is used to categorize documents of a document collection 104 into different classes of documents, including class 1 documents (106-1) up to class N documents (106-N), where N>1. The different classes of documents 106-1 to 106-N are provided to respective analysis engines 108-1 to 108-N. The analysis engines 108-1 to 108-N can apply respective data analysis techniques to the respective classes of documents. Examples of data analysis techniques include data mining techniques, machine learning techniques, and so forth. The analysis engines 108-1 to 108-N produce respective analysis outputs 1 to N.

More generally, the document categorizer 102 applies pre-processing to input documents from the document collection 104 to produce homogeneous sets or clusters of documents. Once homogeneous clusters of documents are identified, respective data analysis techniques can be applied by the corresponding analysis engines 108-1 to 108-N, where each data analysis technique can be optimized or designed for the respective homogeneous cluster of documents.

The clustering of documents into the different classes is based on moments computed for the documents by a moment computation engine 110. In the FIG. 1 example, the moment computation engine 110 is part of the document categorizer 102. In other examples, the moment computation engine 110 can be separate from the document categorizer 102.

A term of a document can refer to a word, a part of a word, or a phrase made up of multiple words in the document. A term can exclude stop words in the document, which are common words (e.g. “the,” “are,” etc.) that appear in a large number of documents. Also, word stemming can be applied to identify terms, where word stemming determines a root of a word (e.g. the term “make” is the root for “making,” “made,” etc.).

To derive moments for respective documents, the moment computation engine 110 first computes feature vectors based on the content of the documents, where each feature vector is produced for a corresponding document, and the feature vector includes values based on frequencies of terms in the corresponding document. More generally, the moment computation engine 110 can generate data structures for respective documents, where each data structure contains information representing an amount of occurrence of terms in the respective document. A feature vector is an example of such data structure.

Based on the feature vector for each document, the moment computation engine 110 further computes at least one moment for the document. Generally, a moment is a quantitative measure of a characteristic of a distribution of values. A first order moment (or “first moment”) represents a mean of the distribution of values. A second order moment (or “second moment”) represents a variance of the distribution of values. A third order moment (or “third moment”) represents a skewness of the distribution of values, and provides an indication of the lopsidedness of the distribution. A fourth order moment (or “fourth moment”) represents the kurtosis of the distribution of values, and provides a measure of whether the distribution is tall and skinny or short and squat. There can be higher order moments that represent other characteristics of the distribution of values.

For each document, the moment computation engine 110 can compute one or multiple ones of the forgoing different order moments. Each moment is computed based on a difference vector, where the difference vector is computed based on the difference between the feature vector of the document and an aggregate (e.g. mean, average, sum, maximum, minimum, etc.) of feature vectors of the documents of the collection 104. The moment represents at least one characteristic of the distribution of values in the difference vector, where the at least one characteristic is selected from among a mean, a variance, a skewness, a kurtosis, and so forth (as discussed above).

For example, if a first feature vector (for a first document) contains values v1, v2, . . . , vM that are based on respective frequencies of occurrence of corresponding terms t1, t2, . . . , tM, then the moment(s) computed by the moment computation engine 110 for the first document is based on a difference vector that is equal to the difference between the first feature vector and an aggregate feature vector that is an aggregate of the feature vectors of the documents of the collection 104. The difference vector contains a distribution of values that are computed by taking the difference between the first feature vector and the aggregate feature vector.

Examples of feature vectors include term frequency-inverse document frequency (TF-IDF) vectors. The values of a TF-IDF vector are TF-IDF statistics, where each TF-IDF statistic is a numerical measure of how important a term is to a document in a document collection. The TF-IDF statistic increases in value proportionally to the number of times a respective term appears in a document, but is offset by the frequency of the term in all of the documents of the collection 104. The TF-IDF statistic is the product of two parameters: term frequency and inverse document frequency. The term frequency can be a measure of the frequency (number of occurrences) of a term in a document (e.g. the number of times the term occurs in the document). The inverse document frequency is a measure of whether the term is common or rare across documents of the document corpora 104. The inverse document frequency is obtained by dividing the total number of documents in the document collection 104 by the number of documents containing the term, and then computing a measure based on the foregoing value. The TF-IDF statistic can be a product of the term frequency and the inverse document frequency.

An example TF-IDF vector 200 for a given document x is shown in FIG. 2. The TF-IDF vector 200 includes multiple entries, more specifically, M entries, where M>1 represents the number of terms that may appear in documents of the collection 104. Each entry of the TF-IDF vector 200 corresponds to a respective term. For example, TF-IDF(t1) represents the TF-IDF statistic for term t1, and TF-IDF(tM) represents the TF-IDF statistic for term tM. Note that a TF-IDF(ti) statistic in the TF-IDF vector 200 may be zero for a corresponding term ti that does not appear in document x.

At least one moment can be computed based on the TF-IDF vector 200. For example, the moment computation engine 110 of FIG. 1 can generate a difference vector by taking the difference of the TF-IDF vector 200 and an aggregate TF-IDF vector that is an aggregate of the TF-IDF vectors of documents in the collection 104.

The difference vector includes multiple TF-IDF statistics that are computed based on taking the difference between the TF-IDF statistics of the TF-IDF vector 200 and the TF-IDF statistics of the aggregate TF-IDF vector.

Certain types of documents, such as machine-generated logs or numerical spreadsheets, have a relatively small number of distinct terms. As a result, the TF-IDF vectors for such documents tend to be peaky, where certain terms have large frequencies while other terms have very low or zero frequencies. Specifically, the TF-IDF vector for any such document would tend to have certain entries that have large values, while other entries have low or zero values.

Other documents, such as written text documents, tend to have terms that are more spread out (there are a larger number of distinct terms and the frequency of occurrence of any one term tends to be closer in value to frequencies of other terms).

For a peaky TF-IDF vector, a moment (e.g. second moment) can be high. However, for a more uniform TF-IDF vector, the moment (e.g. second moment) can be closer to zero.

Thus, moment(s) produced for TF-IDF vectors for different types of document would exhibit generally different characteristics.

In accordance with some implementations, rather than categorize documents based on TF-IDF vectors for respective documents, moments based on the TF-IDF vectors are first computed, and documents are categorized by the document categorizer 102 based on the moments into different classes, according to different moment characteristics.

The categorization of a document based on the moment(s) computed for the document can use one of multiple different techniques. A first technique can be a heuristic-based technique, where moment patterns can be identified (based on analysis of moments for different types of documents by one or multiple users, for example) that represent expected moment characteristics for different classes of documents. For example, for a first class of documents, the moment pattern can specify that the moment(s) for such documents would have value(s) that fall within specified range(s).

With the heuristic-based technique, the moment(s) computed for the document can be compared to the moment patterns of different classes of documents. Based on the comparing indicating that the moment(s) computed for the document most closely matches a given one of the moment patterns, the document is categorized by the document categorizer 102 into a respective one of the different classes.

A different technique is a machine-learning technique, where a classifier can be trained to categorize documents based on moments. To train the classifier, a set of training documents that are labeled with respect to different classes can be input into the classifier, along with the respective moments of these training documents. The classifier can then learn what moments correspond to what classes.

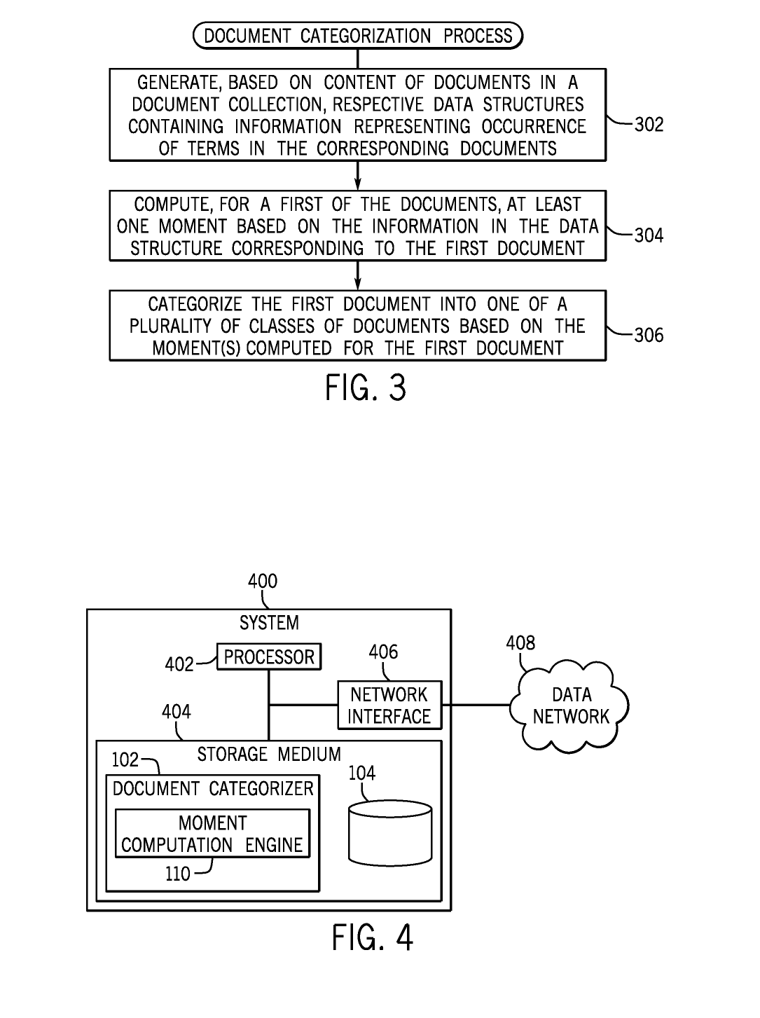

FIG. 3 is a flow diagram of a document categorization process according to some implementations, which can be performed by the document categorizer 102 and the moment computation engine 110 of FIG. 1. The moment computation engine 110 generates (at 302), based on content of documents in a document collection, respective data structures (e.g. TF-IDF vectors or other feature vectors) containing information representing occurrence of terms in the corresponding documents. The moment computation engine then computes (at 304), for a first of the documents, at least one moment based on the information in the data structure corresponding to the first document. The document categorizer 102 then categorizes (at 306) the first document into one of a plurality of classes of documents based on the moment(s) computed for the first document.

FIG. 4 is a block diagram of a system according to some implementations. The system 400 includes the document categorizer 102 and moment computation engine 110, which can be implemented as machine-readable instructions executable on one or multiple processors 402. A processor can include a microprocessor, microcontroller, processor module or subsystem, programmable integrated circuit, programmable gate array, or another control or computing device. The processor(s) 402 can be coupled to a machine-readable or computer-readable storage medium (or storage media) 404 and to a network interface 406. The network interface allows the system 400 to communicate over a data network 408.

The storage medium or storage media 404 can store various information, including the machine-readable instructions of the document categorizer 102 and the moment computation engine 110. In addition, the storage medium or storage media 404 can store the document collection 104.

The storage medium (or storage media) 404 can be implemented using any of different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
generating, by a system having a processor for documents in a collection, respective data structures containing information representing occurrence of terms in the corresponding documents; and
computing, by the system for a first one of the documents, at least one moment based on the information in the data structure corresponding to the first document, wherein the at least one moment represents at least one characteristic of a distribution of values derived from the information in the data structure corresponding to the first document, and wherein the at least one moment is useable to categorize the first document into one of a plurality of classes of documents.

2. The method of claim 1, wherein generating the data structures comprises generating feature vectors, each of the feature vectors including a plurality of values, each of the values based on a respective amount of occurrence of a respective one of the terms.

3. The method of claim 2, wherein the values are based on respective frequencies of occurrence of the terms.

4. The method of claim 2, wherein generating the feature vectors comprises generating term frequency-inverse document frequency (TF-IDF) vectors.

5. The method of claim 1, further comprising:
computing the distribution of values based on the information in the data structure corresponding to the first document, and information of an aggregate data structure that is an aggregate of data structures for the corresponding documents in the collection.

6. The method of claim 5, wherein the aggregate data structure is derived based on computing a mean of the data structures for the corresponding documents in the collection.

7. The method of claim 1, further comprising:
categorizing the first document into the one of the plurality of classes of documents based on the at least one moment.

8. The method of claim 7, further comprising:
selecting one of a plurality of processing engines for processing respective different types of documents, the selecting based on the categorizing of the first document; and
providing the first document to the selected processing engine.

9. The method of claim 7, wherein the categorizing uses a heuristic-based technique that matches the at least one moment to a specified pattern.

10. The method of claim 7, wherein the categorizing uses a classifier that has been trained to categorize documents using moments.

11. A system comprising:
at least one processor to:
compute feature vectors for respective documents in a collection, each of the feature vectors containing values indicating corresponding occurrence of respective terms in the respective document;
derive a distribution of values based on the feature vector for a first of the documents;
compute at least one moment based on the distribution of values, the least one moment representing at least one characteristic of the distribution of values; and
categorize the first document into one of a plurality of classes based on the at least one moment.

12. The system of claim 11, wherein the distribution of values is derived based on a difference between the feature vector for the first document and an aggregate feature vector computed based on aggregating feature vectors for respective documents in the collection.

13. The system of claim 11, wherein the at least one moment comprises a second order moment.

14. The system of claim 11, further comprising:
a plurality of analysis engines configured for respective different classes of documents, wherein the at least one processor is to further:
select one of the plurality of analysis engines according to the categorizing of the first document; and
provide the first document to the selected analysis engine for processing.

15. The system of claim 11, wherein the feature vectors include term frequency-inverse document frequency (TF-IDF) feature vectors.

16. The system of claim 11, wherein the at least one processor is to categorize the first document by comparing the at least one moment to specified moment patterns for the respective plurality of classes.

17. The system of claim 11, wherein the at least one processor is to categorize the first document using a classifier.

18. An article comprising at least one machine-readable storage medium storing instructions that upon execution cause a system to:
generate, for documents in a collection, respective data structures containing information representing occurrence of terms in the corresponding documents;
compute, for a first one of the documents, at least one moment based on the information in the data structure corresponding to the first document, wherein the at least one moment represents at least one characteristic of a distribution of values derived from the information in the data structure corresponding to the first document; and
categorize, using the at least one moment, the first document into one of a plurality of classes of documents.

19. The article of claim 18, wherein the at least one characteristic comprises a variance of the distribution of values.

20. The article of claim 18, wherein computing the at least one moment comprises computing a plurality of moments of different orders.
